(19) United States
(12) Patent Application Publication
(10) Pub. No.: US 2012/0193859 A1
(43) Pub. Date: Aug. 2, 2012

(54) Orbiting Cam Drive Mechanism, Pitch Changing Device and Method

(75) Inventors: Joseph Adrian St. Ours, Lee, NH (US); John James Sposato, Dover, NH (US); Keith James Calderone, Dover, NH (US)

(73) Assignee: GOSS INTERNATIONAL AMERICAS, INC., Durham, NH (US)

(21) Appl. No.: 13/316,680

(22) Filed: Dec. 12, 2011

Related U.S. Application Data
(60) Provisional application No. 61/459,278, filed on Dec. 10, 2010.

(51) Int. Cl. B41F 13/56; B31B 1/56; B65H 9/00

(52) U.S. Cl. 270/20.1; 271/264; 493/454

(57) ABSTRACT

A printing press is provided. The printing press includes at least one printing unit printing on a web, a folder for forming the web into a plurality of signatures, the plurality of signatures traveling in a stream at an initial pitch and a pitch changing device for changing the initial pitch of the plurality of signatures in the stream. The pitch changing device includes a first orbiting member orbiting about a first axis and rotating about a second axis and a second orbiting member orbiting about a third axis and rotating about a fourth axis. The first orbiting member and second orbiting member form a nip and the nip receives a stream of signatures. The first and second orbiting members vary a velocity of the signatures so as to alter the initial pitch. A folder and a method for changing a pitch between consecutive signatures is also provided.

Priority is hereby claimed to U.S. Provisional Application No. 61/459,278 filed on Dec. 10, 2010, the entire disclosure of which is hereby incorporated by reference herein.

The present invention relates generally to drive mechanisms used in printing press and more specifically drive mechanisms used in a folder of a printing press.

### BACKGROUND

U.S. Publication No. 2009/0217833 discloses a pitch changing device. The pitch changing device includes an upper roller mounted on an upper axle, a lower roller mounted on a lower axle, the upper and lower rollers forming a roller nip and a motor driving the upper and lower rollers in opposite directions. The motor has an electronic cam velocity profile designed to increase or decrease pitch of the printed products by increasing or decreasing the velocity of the printed products, respectively.

U.S. Pat. No. 6,572,097 purportedly discloses a signature slow-down section in a folder of a printing press for slowing down signatures. The folder is driven by a folder drive mechanism. The signature slow-down section includes a frame, a slow-down mechanism supported by the frame and a motor connected to the slow-down mechanism for rotatably driving the slow-down mechanism separately from the folder drive mechanism.

A folder, for example, a pinless combination folder such as the PCF-3 manufactured by Goss International Americas, Inc. may produce a full range of product types including, for example, magazine, delta fold, digest, tabloid and slim jim products. The PCF-3 includes a double cut process that separates signatures in two steps to maintain continuous, positive control. A dynamic diverter positioned in-line with the product flow minimizes jams when splitting the stream and a speed matched slowdown in the quarterfolder slows signatures smoothly without marking.

Offset couplings, elliptical gears, planetary gear devices and Schmidt couplings are used to connect shafts that may be misaligned or are not collinear. However such devices may not be industrial enough to withstand the demanding requirements of the eccentric tube style slow downs or requirements of current folders.

### SUMMARY OF THE INVENTION

In a printing operation, printed products or signatures move through a printing press at maximum press speeds which may be considerably faster than speeds that can be accommodated in equipment downstream such as folders, and more specifically, choppers and fans. Slowing down the printed products reduces forces acting on the printed products, allows for better control of the printed products and produces more accurate final products.

In known printing press equipment, a deceleration or slowdown mechanism may be utilized to decelerate printed products as printed products exit a printing section of a printing press. The deceleration mechanism implements mechanical structures that may include Schmidt couplings which engage and decelerate the individual printed products or signatures. The constant stress of multiple decelerations for a substantial number of signatures encountered in commercial printing operations causes durability problems with known deceleration solutions.

Previous attempts to improve the prior art include designing larger couplings, electronic cam slow downs and torque limiters.

An object of present invention is to provide a more robust design to address the failures in the field including the demanding requirements of eccentric tube style slow downs. The present invention may replace Schmidt couplings on legacy slow-down or deceleration devices such as those used on the GOSS PCF-3 folder.

The present invention provides a printing press. The printing press includes at least one printing unit printing on a web, a folder for forming the web into a plurality of signatures, the plurality of signatures traveling in a stream at an initial pitch and a pitch changing device for changing the initial pitch of the plurality of signatures in the stream. The pitch changing device includes a first orbiting member orbiting about a first axis and rotating about a second axis and a second orbiting member orbiting about a third axis and rotating about a fourth axis. The first orbiting member and second orbiting member form a nip and the nip receives a stream of signatures. The first and second orbiting members vary a velocity of the signatures so as to alter the initial pitch.

The present invention also provides a folder. The folder has a drive mechanism. The drive mechanism includes a first input member rotating in a first direction about a first axis, a second input member concentric with the first input member and rotating in a second direction about the first axis. The second direction is opposite to the first direction. The drive mechanism also includes a plurality of cams connected to the second input member and an orbiting output member. The orbiting output member rotates about a second axis and orbits about the first axis. The second axis is connected to a point on the first input member; the second axis rotates about the first axis. The drive mechanism further includes a plurality of cam followers connected to the orbiting output member and contacting the plurality of cams, the plurality of cam followers rotating about the second axis in the second direction.

The present invention further provides a method for changing a pitch between consecutive signatures in a signature stream. The method includes the steps of moving a plurality of signatures at an initial velocity and an initial pitch, rotating a nip of a first nip segment and a second nip segment at an initial velocity, receiving a plurality of signatures at the nip, rotating the first nip segment about a first axis and the second nip segment about a second axis, orbiting the first nip segment about a third axis and orbiting a second nip segment about a fourth axis so as to change the initial pitch of the plurality of signatures.

### BRIEF DESCRIPTION OF THE DRAWINGS

The invention will be better understood from a reading of the following description, given purely by way of example, with reference to the appended drawings, in which:

FIG. 1 shows a schematic representation of a printing press including a drive mechanism according to the present invention;

FIG. 2 shows the drive mechanism shown in FIG. 1;

FIG. 3 shows the drive mechanism as shown in FIGS. 1 and 2;

FIGS. 4A to 4E show the drive mechanism of FIG. 1 rotating at 90 degree increments;

FIG. 5 shows the drive mechanism of FIG. 3 having a nip wheel attached thereto;

FIG. 6 shows an upper and a lower drive mechanism acting on a signature in accordance with a preferred embodiment of the present invention;

FIG. 7 shows a preferred embodiment of the drive mechanism having four cam followers in accordance with the present invention;

FIG. 8 shows another preferred embodiment of the mechanism having six cam followers in accordance with the present invention;

FIGS. 9A to D show the drive mechanism shown in FIG. 6 throughout rotation;

FIGS. 10 and 11 show surface speeds for an eccentric nip surface and concentric nip surface, respectively; and

FIG. 12 shows a drive mechanism having a concentric nip in accordance with a further preferred embodiment of the present invention.

### DETAILED DESCRIPTION OF A PREFERRED EMBODIMENT

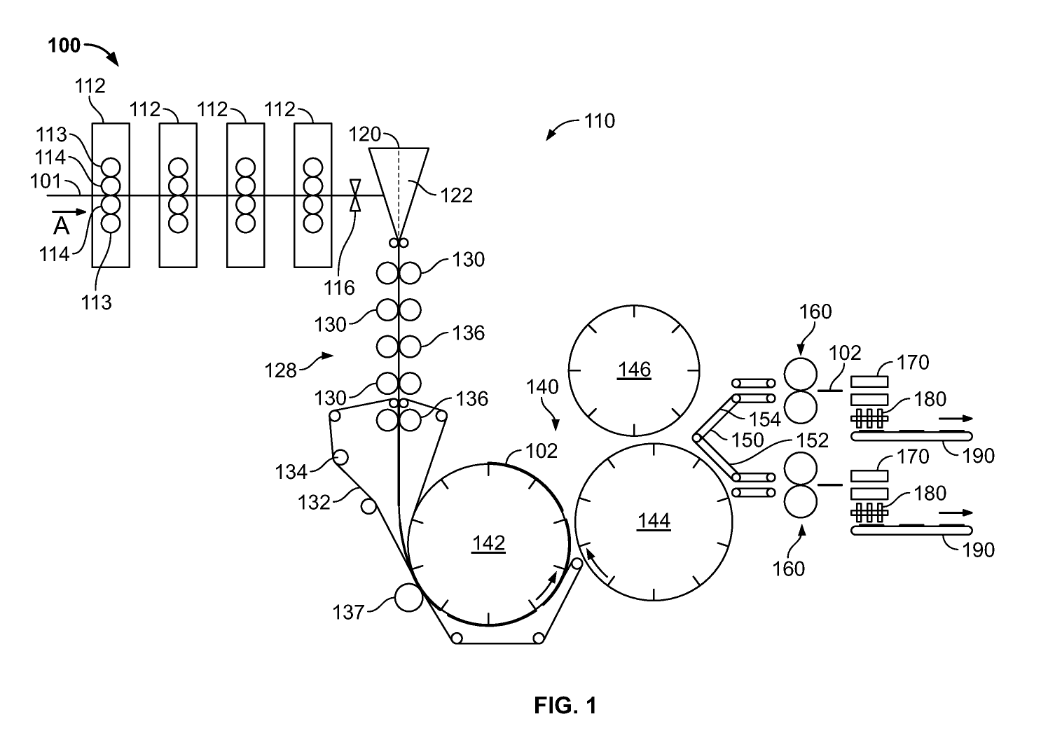

FIG. 1 shows a schematic representation of a printing press including a drive mechanism in accordance with the present invention. Printing press 100 may be, for example, a four color web offset printing press. Printing units 112 may each include two print couples, each couple including a plate cylinder 113 and a blanket cylinder 114. Each couple prints on either side of a web 101. Each print unit 112 may print a different a color, for example, magenta, cyan, yellow or black.

After printing, web 101 may be slit into a plurality of ribbons by a slitter 116, if desired. The ribbons may be combined and transported to a former 120 for longitudinal folding. The former fold 122 is in line with a direction of travel A of web 101. Printing press 100 may include a folder 110 for folding, cutting and processing web 101 into signatures 102.

Folded web 101 may be transported through a plurality of nip rolls 130 to a cutting section 128 of folder 110. Tapes 132 may be used to guide web 101 through cutting section 128 and a folding section 140. Tapes 132 are supported by guide rollers 134. In one embodiment, cutting section 128 includes two pairs of cutting cylinders 136. Cutting cylinders 136 cut web 101 into signatures 102. The first pair of cutting cylinders 136 may partially cut or perforate the web, the second pair of cutting cylinders 136 may provide a final cut to cut signatures 102 from web 101. Signatures 102 are then gripped by grippers on collect cylinder 142 in folding section 140. Grippers may be pinless grippers, for example, mechanical or vacuum grippers, or grippers may be pins. Signatures 102 may be transported around collect cylinder 142 as many times as desired so additional signatures 102 may be deposited at the same gripper location on collect cylinder 142. The collected signatures 102 are transferred to a jaw of jaw cylinder 144. Alternatively, the collect cylinder 142 may run in straight mode and only one signature 102 will be transferred to a jaw of jaw cylinder 144.

In another preferred embodiment, an additional jaw or folding cylinder 146 may be provided to create an extra fold in the collected signature(s) 102 if desired. In a further preferred embodiment, a single cutting cylinder 137 may cut signatures 102 from web 101 in a single cut against collect cylinder 142.

Signatures 102 are subsequently separated into two signature streams 152, 154 via a diverter 150 located downstream of cutting section 140. In accordance with the present invention, a drive mechanism 160 may slow down signatures 102 and change an initial pitch of signatures 102 in streams 152, 154. From drive mechanism 160, signatures 102 may be transported to a chopper folder or quarter folder 170, a fan 180 and a conveyor 190 for delivery or further downstream processing.

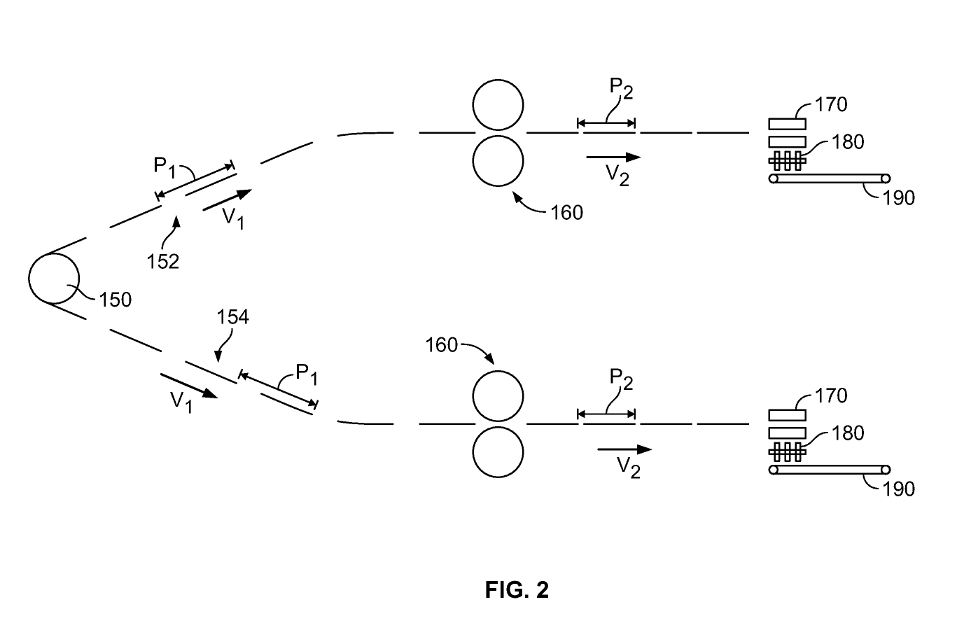

FIG. 2 shows the diverter 150, streams 152, 154 and drive mechanisms 160 shown in FIG. 1. Typically, diverters and slowdowns will be used in conjunction with each other to slowdown and separate the printed product or signature streams. There may be one diverter and two slowdowns, each slowdown device receiving a stream of printed products from the diverter.

As shown in FIG. 2, after signatures 102 pass through drive mechanism 160 an initial or first pitch P₁ between consecutive signatures 102 is decreased to a second pitch P₂ between consecutive signatures. Pitch is typically measured as the distance between leading edges of consecutive signatures in the direction of travel. In this embodiment, drive mechanisms 160 slow down signatures 102 and thereby decrease the pitch between signatures 102.

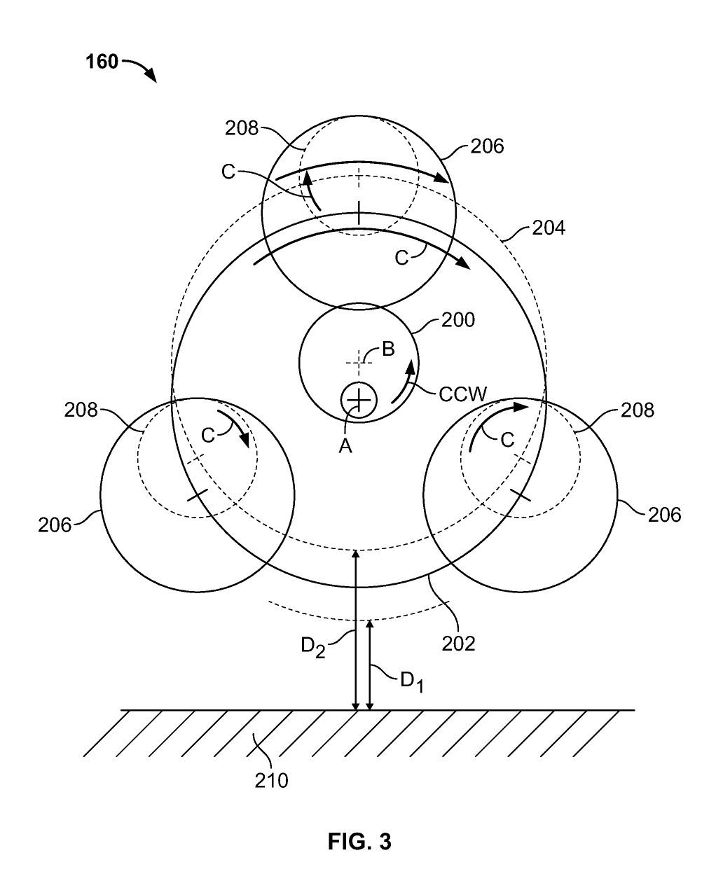

FIGS. 3 to 8 show drive mechanism 160 in more detail in accordance with the present invention. Drive mechanism 160 includes a first input drive member 200, for example, a crankshaft, and a second input drive member 202, for example, a cam carrier, which together create an orbiting motion of a third output drive member 204, for example, a cam follower carrier.

A plurality of cams or cam surfaces 206 are connected to second input member 202. As shown in FIGS. 3, 7 and 8, any number of cams or cam surfaces may be provided as desired. The preferred embodiments shown herein include three, four or six cam surfaces, for example. As shown in FIGS. 7 and 8 cam surfaces 306 and 406, are integral with second input drive members 302 and 402 respectively, which are cam carriers.

First input member 200 and second input member 202 share a common first center axis or point A and are thus concentric with each other. First input member 200 and second input member 202 both rotate about first point or axis A. Input members 200 and 202 rotate at equal speeds; however, members 200 and 202 rotate in opposite directions. For example, as indicated in FIG. 3, first input member 200 is rotating in a counterclockwise direction CCW about first axis A while second input member is rotating in clockwise C direction about first axis A.

A third output drive member 204 rotates about a second center point or axis B. Second center point or axis B is fixed to first input drive member 200 and therefore second axis B rotates about first axis A at the same speed and direction as first input drive member 200. Thus, second axis B rotates counterclockwise about first axis A. As a result, third output drive member 204 rotates about second axis B and orbits first axis A described below in more detail.

Third output drive member 204 includes a plurality of cam followers 208. As shown in FIGS. 3, 7 and 8 and discussed above with respect to cam surfaces 206, any number of cam followers 208 may be provided as desired. The preferred embodiments shown herein include three, four or six cam followers, 208, 308, 408, for example. Cam followers 208 are concentric with third output drive member 204 about second axis B.

Cam surfaces 206 are integral with or attached to second input drive member 202 and, as a result, rotate in the same direction and at the same speed as second input drive member 202. Thus, cam surfaces rotate about first axis A in the clockwise direction C with second input drive member 202.

Cam followers 208 are following cam surfaces 206. The contact between cam followers 208 and cam surfaces 206 forces cam followers 208 to rotate about second axis B at the same rotary speed and direction as cam surfaces 206 and second input drive member 202. Thus, cam followers 208 rotate about second axis B in the clockwise direction C.

Now, second axis B is rotating about first axis A in a counterclockwise direction at the same speed as first input drive member 200. Second input drive member 202 is rotating at the same speed as second axis B and first input drive member 200, however, in the opposite direction, clockwise. These rotations in addition to the clockwise rotation of cam followers 208 forces third drive output member 204 to rotate about second axis B at the same rotary speed and direction as second input drive member 202, thus, in the clockwise direction C.

Third output drive member 204 is rotating clockwise about the second center axis B which is rotating counterclockwise about first axis A, so third input drive member 204 is forced to follow and orbit around first axis A while at the same time rotating at an equal speed and in the same direction, clockwise, as second drive input member 202. Since the center of third output drive member 204, second axis B, is orbiting around first axis A, third output drive member 204 moves away from a ground 210 through a first half of an orbit about point A as represented by far distance D₂ and approaches ground 210 through a second half of the orbit about point A represented by near distance D₁. Since third output drive member 204 rotates at a constant speed about second axis B, the tangential velocity of any point at a fixed distance from second axis B also remains constant.

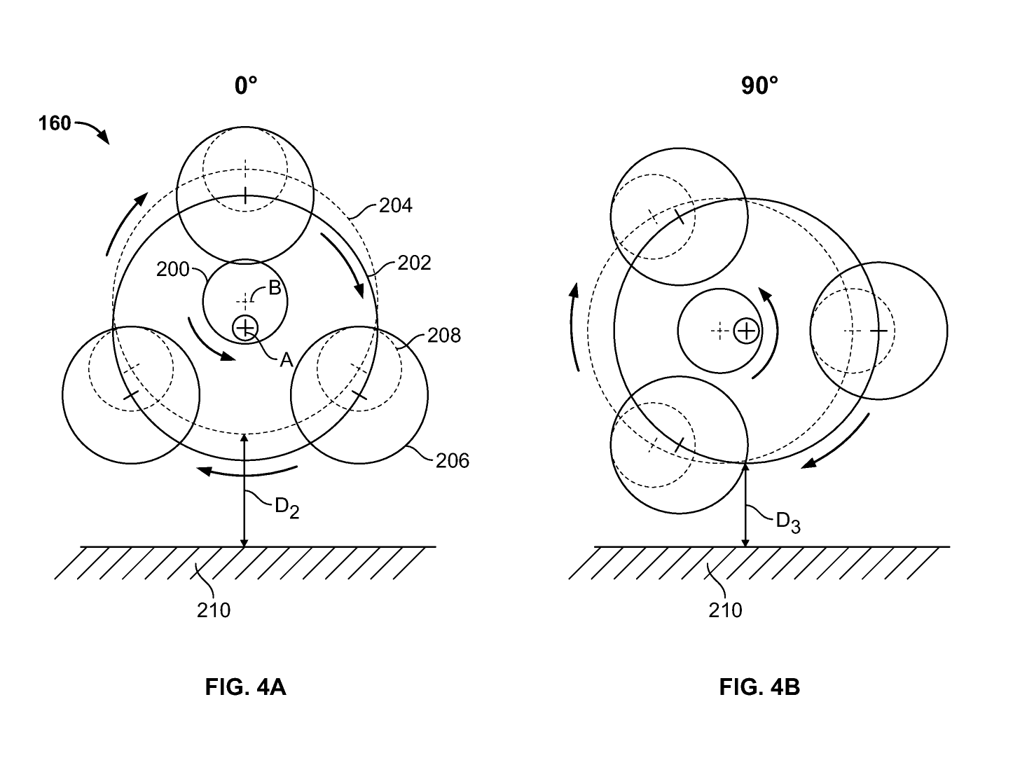

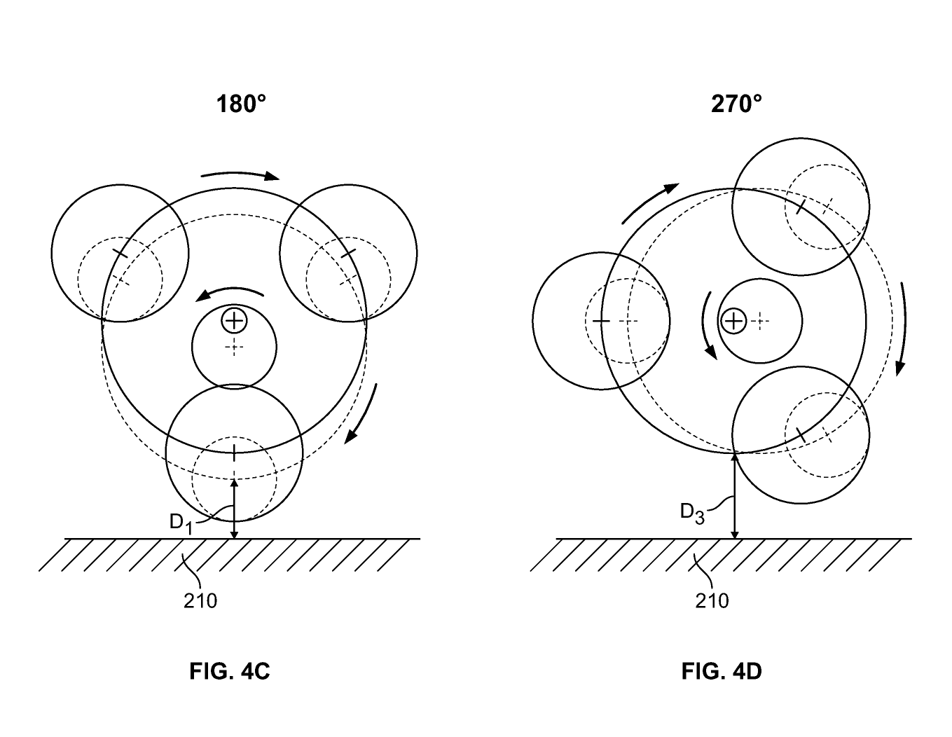

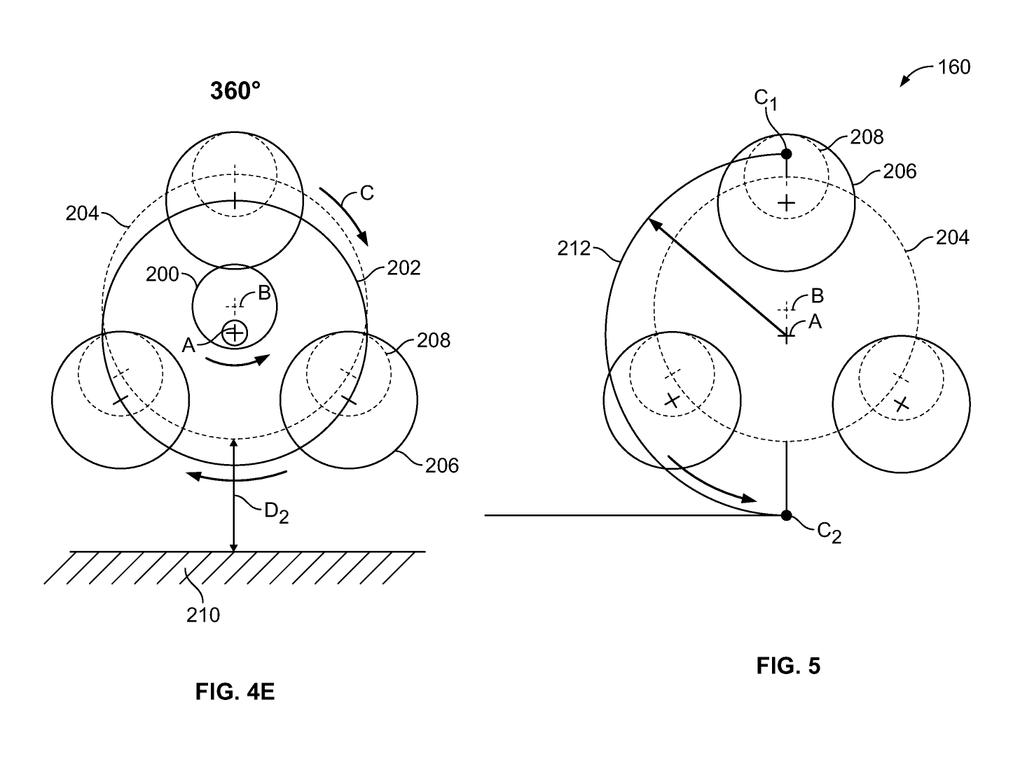

FIGS. 4A to 4E show orbiting drive mechanism 160 rotating at 90 degree increments. FIG. 4A shows orbiting drive mechanism 160 at 0 degrees with third output drive member 204 at far distance D₂ from ground 210. FIG. 4B shows drive mechanism 160 rotated 90 degrees with third output drive member 204 at an intermediate distance D₃ from ground 210. FIG. 4C shows drive mechanism 160 rotated 180 degrees. Third output drive member 204 is halfway through its orbit about first axis A and is at a near distance D₁ from ground 210. FIG. 4D shows drive mechanism 160 rotated 270 degrees with third output drive member 204 at an intermediate distance D₃ from ground 210. FIG. 4E shows orbiting drive mechanism 160 rotated 360 degrees. Third drive output member 204 is located at far distance D₂ from ground 210.

The properties of orbiting drive mechanism 160 may be used to create a pitch changing device to reduce or increase the speeds and pitches of signatures as signatures interact with orbiting drive mechanism 160. FIG. 5 shows orbiting drive mechanism 160 with a nip wheel 212. Nip wheel 212 is attached to third output drive member 204. Nip wheel 212 shown in FIG. 3 is a partial or half nip wheel segment. Nip wheels 212 may be any segment size desired including a fully round nip wheel.

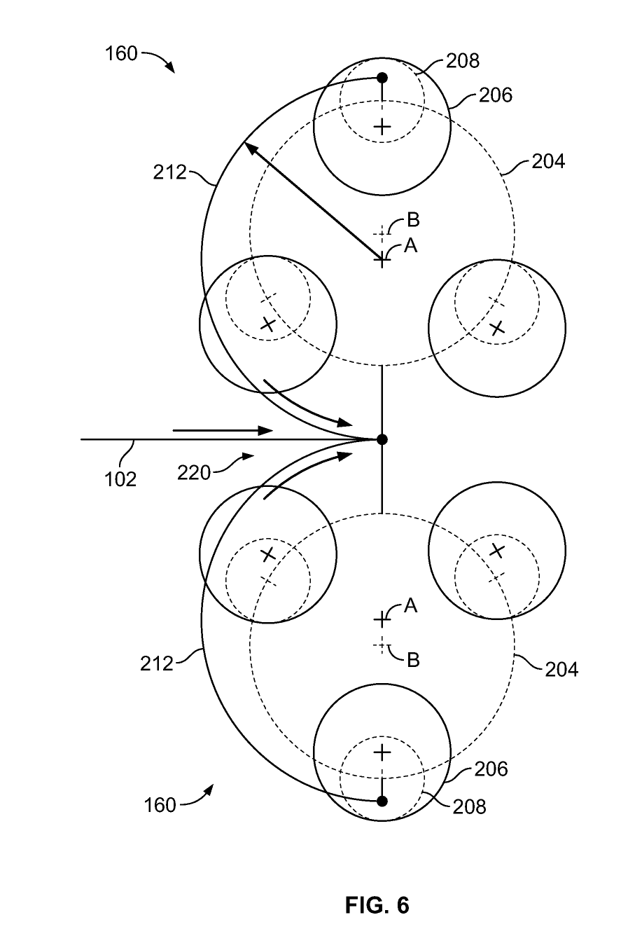

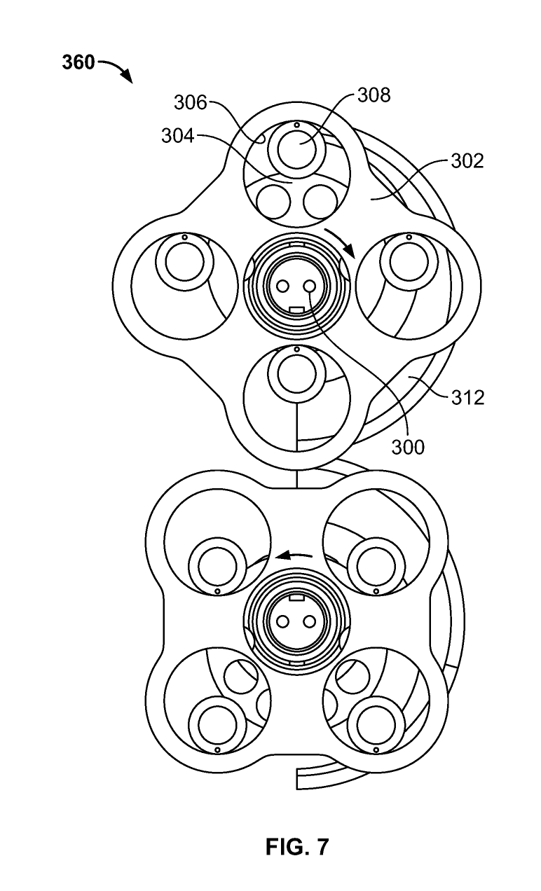

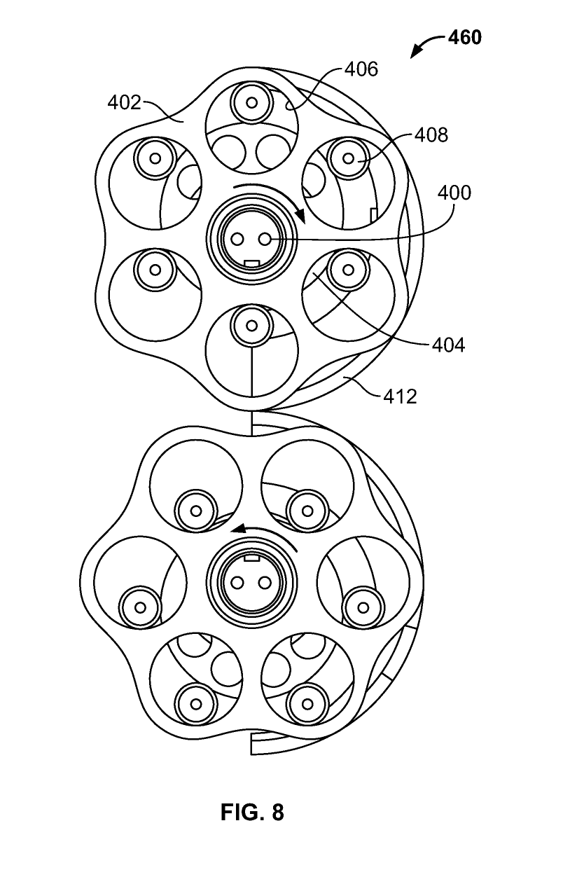

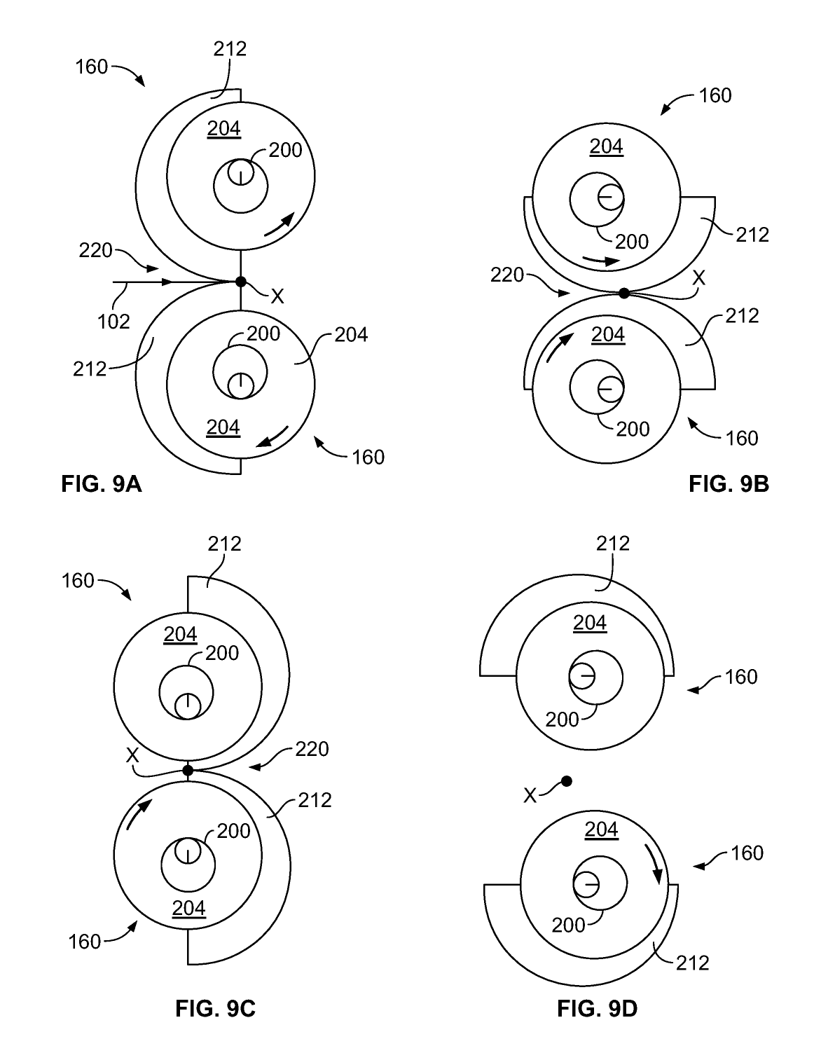

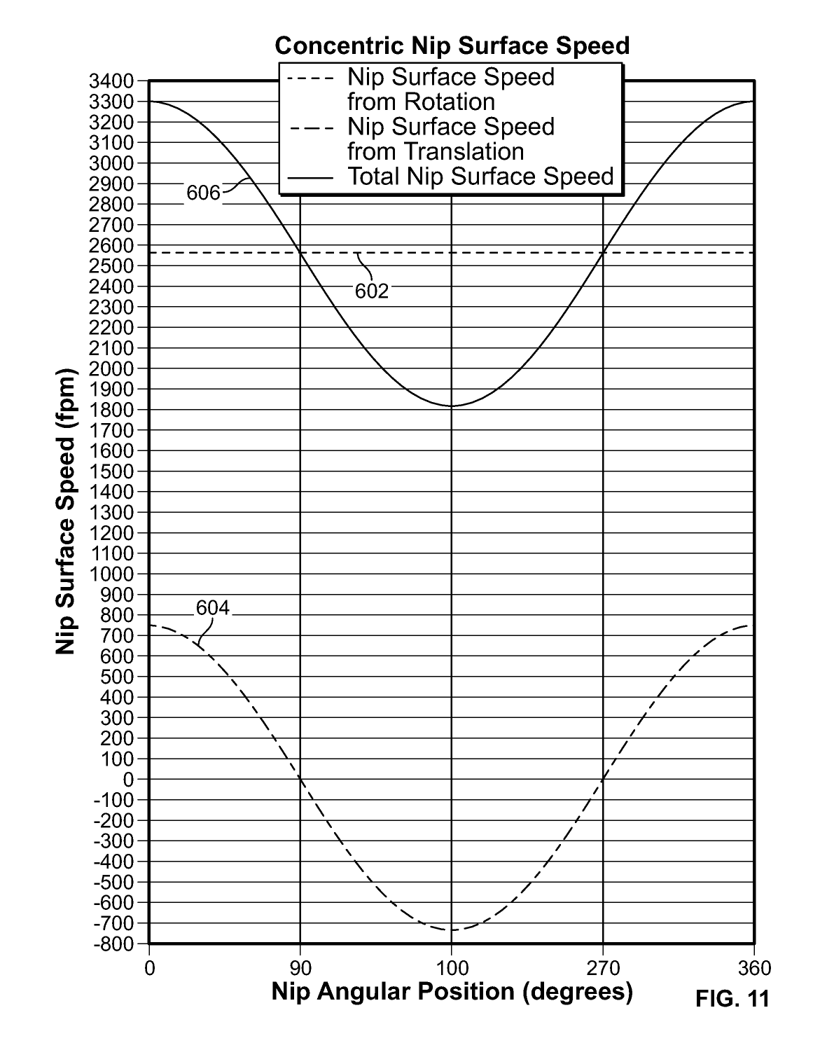

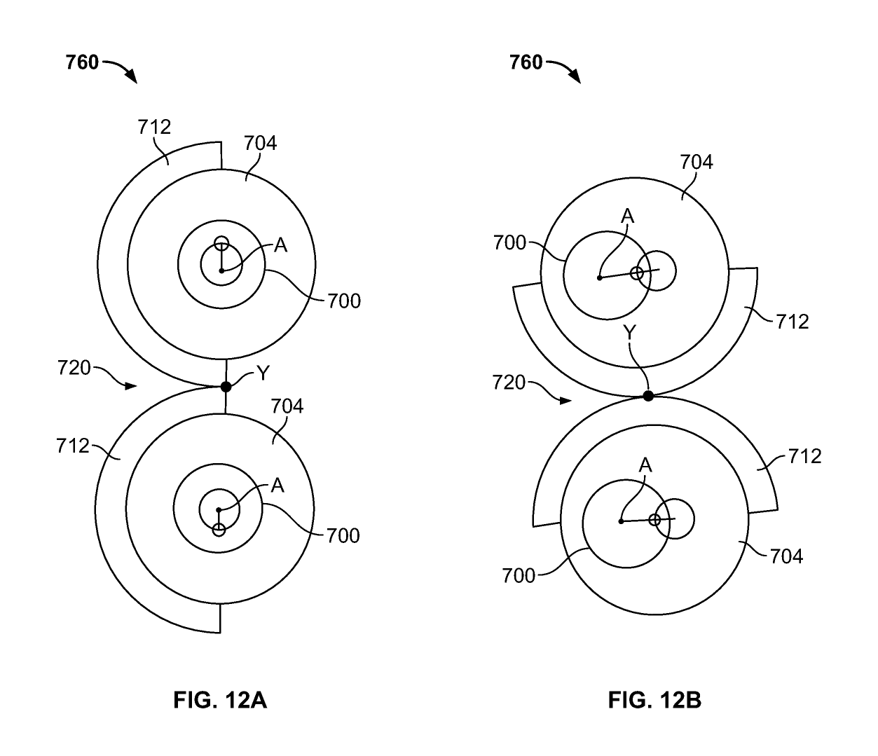

Nip wheel 212 orbits about first axis A with third output drive member 204. However, nip wheel 212 is connected to third output drive member 204 in such a way that nip wheel 212 is concentric with first input drive member 200 and second input drive member 202 about first axis A. In a preferred embodiment, half nip wheel 212 has an increasing thickness along a circumference of third output drive member 204 as shown thereby providing an eccentric nip 220 (FIGS. 6 and 9A to 9D). For example, a distance from second axis B to a point C₁ is less than a distance from second axis B to a point C₂. Alternatively, a concentric nip 720 may be provided as shown in FIGS. 11 and 12 and described below.

By arranging nip wheel 212 on third drive output member 204 in this manner, a point X (See FIGS. 6 and 9A to 9D) that is in contact with a signature 102 follows a sinusoidal velocity profile in the direction of signature travel due to the arrangement of first axis A and first axis B, resulting in a reduction in initial pitch P₁ between signatures 102 (FIG. 2). A further benefit of mounting nip wheel 212 eccentrically with respect to third output drive member 204 occurs in that a surface of nip wheel 212 will remain in contact with signature 102 as third drive output member 204 orbits first axis A. By altering the eccentricity of first input drive member 200 and first axis A with respect to second axis B and third output drive member 204, drive mechanism 160 may provide any number of possible pitch and speed variations.

FIG. 6 shows a signature 102 to be acted on by upper and lower orbiting drive mechanisms 160. Lower mechanism 160 has the same configuration as upper mechanism 160, including first input drive member 200, second input drive member 202, third output drive member 204, a plurality of cam surfaces 206, a plurality of cam followers 208, a first axis A, a second axis B and a partial nip wheel 212. Lower orbiting mechanism 160 is oriented to act in unison with upper orbiting drive mechanism 160. Upper and lower orbiting mechanisms 160 work together to alter speed and pitch of signature 102 as signature 102 passes between the upper and lower mechanisms 160.

As shown in FIGS. 2 and 6, signatures 102 are spaced apart at initial pitch P₁ in streams 152 and 154. Signatures 102 are transported an initial velocity V₁ to drive mechanisms 160. Tapes may be used to assist with the transport of signatures 102. Once nip wheels 212 contact a portion of signature 102, signature 102 begins to slow down. When signature 102 is released from drive mechanisms 160, signature 102 is moving at a second or final velocity V₂ which is slower than initial velocity V₁, in this example. Slowing down signatures 102 is desirable and often required because many downstream chopper folders, quarter folders and/or fans cannot process signatures at a rate equal to that of upstream printing and folding equipment. Thus, drive mechanisms 160 reduce the pitch between consecutive signatures 102 to final pitch P₂, in this example. Hence, signatures 102 are closer together and traveling at a lower velocity for further downstream processing. As shown in FIGS. 1 and 2, signatures 102 may be folded again by a chopper folder or quarter folder 170 delivered to a fan 180 and further delivered to a conveyor 190.

As discussed above, any number of cam followers with any desired diameter may be arranged to create the desired orbital output disclosed in accordance with the present invention. FIG. 7 shows a device having four cam surfaces 306 and four cam followers 308 and FIG. 8 shows a device having six cam surfaces 406 and six cam followers 408. FIGS. 7 and 8 also show cam surfaces 306 and 406 being integral with second input drive members 302 and 402, respectively.

FIGS. 9A to 9D show the rotation of drive mechanisms 160 with nip wheels 212 attached thereto at 90 degree increments. Two nip wheels 212 on upper and lower drive mechanisms 160 form a nip 220 that engages and slows down an incoming signature 102. A signature 102 enters nip 220 at initial velocity V₁ at a point of contact X shown in FIG. 9A. The velocity of nip 220 matches the velocity V₁ of incoming signature 102. The orbiting motion of drive mechanism 160 translates to a slower linear motion, thus signature 102 is slowed down. After a first signature 102 is released from nip 220, nip 220 picks up speed as drive mechanism 160 rotates in order to reach the initial velocity V₁ of the next incoming signature 102.

As shown in FIGS. 9A to 9D, point of contact X moves laterally throughout the orbit of third output drive member 204. The translational motion of point X is sinusoidal and the velocity profile of point X is sinusoidal due to the interaction of first input member 200 and second input member 202 rotating about axis A and orbiting third output drive member 204 rotating about second axis B and orbiting about axis A. Nip 220 and corresponding nip wheels 212 are continuously rotating, however nip 220 is simultaneously moving forward and backward in the direction of signature 102 travel. As shown in FIG. 9B, point of contact X is translated to the right and in FIG. 9D, and point of contact X is translated to the left when compared to the locations of the point of contact X in FIGS. 9A and 9C.

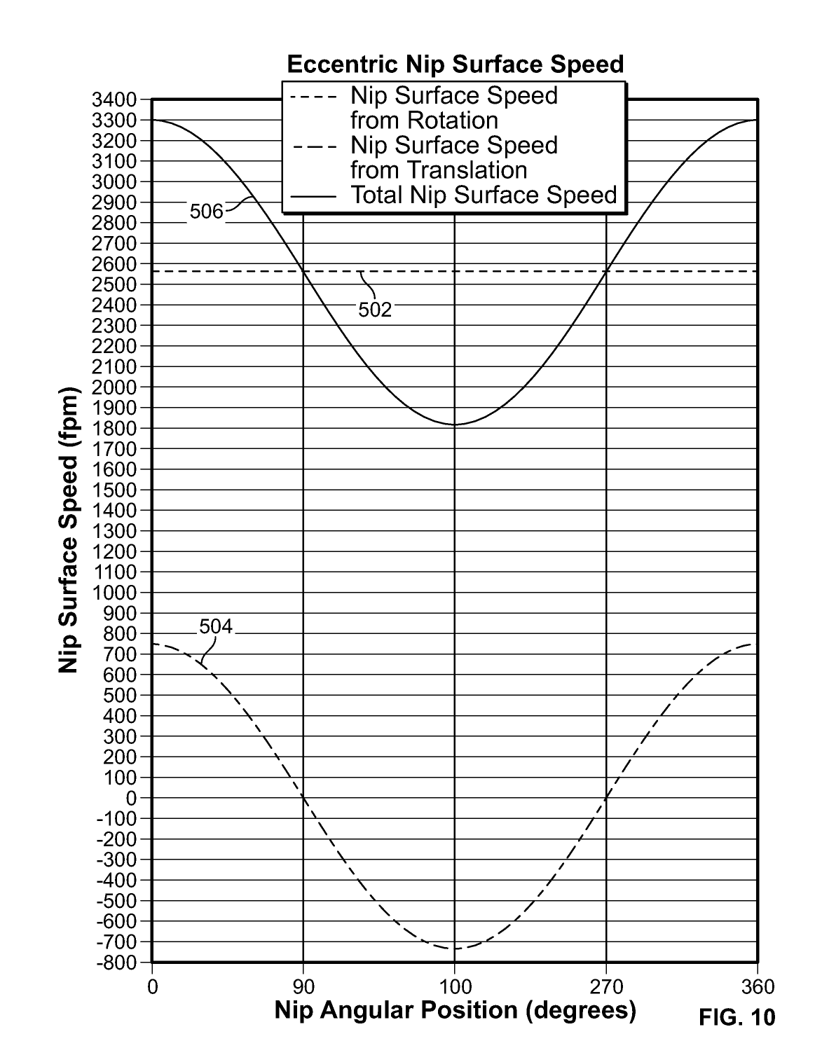

FIG. 10 shows a nip surface speed from rotation 502 which is the change in speed of a surface of nip 220 caused by the rotation of third output drive member 204 (see FIGS. 9A to 9D) for nip 220 which includes eccentric nip wheels 212. As discussed above, third output drive member 204 runs at a constant speed during rotation so nip surface speed from rotation 502 remains constant throughout rotation of drive mechanism 160. A nip surface speed from translation 504 is also shown throughout rotation of drive mechanism 160. The changes in nip surface speed from translation 504 represent the change in speed of point of contact X (see FIGS. 9A to 9D) throughout rotation of drive mechanism 160. A speed of point of contact X is speeding up and slowing down as point of contact X follows a sinusoidal curve throughout rotation. Superimposing nip surface speed from rotation 502 and nip surface speed from translation 504 results in a change in surface speed of nip 220, a total nip surface speed 506. In this example, nip surface speed from translation 504 combined with nip surface speed from rotation 502 causes a net slowdown effect.

FIGS. 12A and 12B show a drive mechanism 760 including a first input drive member 700, second input drive member and third output drive member 704. Drive mechanism 760 is similar to drive mechanism 160, however, drive mechanism 760 includes a concentric nip 720. Nip wheels 712 are attached to third output drive members 704 forming a concentric nip 720. Nip wheels 712 shown in FIG. 12 are partial or half nip wheel segments, but may be any segment size desired including a fully round nip wheel. In this embodiment, half nip wheels 712 have a constant thickness along a circumference of third output drive members 704 as shown, thereby providing concentric nip 720. Third output drive members 704 have a rotational movement and horizontally translational movement that generate the same effect provided on nip surface speed as the eccentric nip 220 of FIGS. 6 and 9A to 9D.

FIG. 11 shows a nip surface speed from rotation 602 which is the change in speed of a surface of nip 720 (FIGS. 12A and 12B) caused by rotation of third output drive members 704 (see FIGS. 12A to 12B) for concentric nip 720 which includes concentric nip wheels 712. As discussed above with respect to third output drive member 204, third output drive member 704 runs at a constant speed during rotation so a nip surface speed from rotation 602 remains constant throughout rotation of drive mechanism 760. A nip surface speed from translation 604 is also shown throughout rotation of drive mechanism 760. The changes in nip surface speed from translation 604 represent the change in speed of a point of contact Y throughout rotation of drive mechanism 760. A speed of point of contact Y is speeding up and slowing down as point of contact Y follows a sinusoidal curve throughout rotation. Superimposing nip surface speed from rotation 602 and nip surface speed from translation 604 results in a change in surface speed of nip 720, a total nip surface speed 606. In this example, nip surface speed from translation 604 combined with nip surface speed from rotation 602 causes a net slowdown effect.

The present invention may be used on any machine that desires to vary the pitch and velocity of an incoming product stream.

In addition, the present invention may be used as a drive mechanism that provides offset coupling. For example, if first input drive member 200 is held stationary, and second input member 204 is rotating with cam surfaces 206 then cam followers 208 and third output drive member are forced to rotate at a constant velocity at the offset of the eccentric, thus about second axis B.

Furthermore, the present invention may be used in a manner in which the second input drive member 202 and cam surfaces 206 are held stationary and first input drive member 200 is rotating. As a result, cam followers 208 engaging cam surfaces 206 orbit around first axis A causing third input member 204 to also orbit around first axis A without rotating a position of nips 220. An indexing device may incorporate this embodiment.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
at least one printing unit printing on a web;
a folder for forming the web into a plurality of signatures, the plurality of signatures traveling in a stream at an initial pitch; and
a pitch changing device for changing the initial pitch of the plurality of signatures in the stream including:
a first orbiting member orbiting about a first axis and rotating about a second axis;
a second orbiting member orbiting about a third axis and rotating about a fourth axis;
the first orbiting member and second orbiting member forming a nip;
the nip receiving the stream of signatures;
the first and second orbiting members varying a velocity of the signatures so as to alter the initial pitch.

2. The printing press as recited in claim 1 wherein the pitch changing device also includes a first input member rotating in a first direction about the first axis, a second input member concentric with the first input member and rotating in a second direction about the first axis, the second direction being opposite to the first direction, a plurality of cams connected to the second input member, the second axis being connected to a point on the first input member, the second axis rotating about the first axis and a plurality of cam followers connected to the first orbiting member and contacting the plurality of cams, the plurality of cam followers rotating about the second axis in the second direction.

3. The printing press as recited in claim 2 wherein the pitch changing device also includes a third input member rotating in a third direction about the third axis, a fourth input member concentric with the third input member and rotating in a fourth direction about the third axis, the fourth direction being opposite to the third direction, a plurality of cams connected to the fourth input member, the fourth axis being connected to a point on the third input member, the fourth axis rotating about the third axis and a plurality of cam followers connected to the second orbiting member and contacting the plurality of cams, the plurality of cam followers rotating about the fourth axis in the fourth direction.

4. The printing press as recited in claim 1 wherein the second axis rotates around the first axis and the fourth axis rotates around the third axis.

5. The printing press as recited in claim 1 wherein the second axis is offset from the first axis and the third axis is offset from the fourth axis.

6. The printing press as recited in claim 1 wherein the first orbiting member and second orbiting member each include a nip segment mounted thereon.

7. The printing press as recited in claim 6 wherein the nip segments are mounted eccentrically on the first orbiting member and the second orbiting member.

8. The printing press as recited in claim 6 wherein a thickness or height of the nip segment varies along a circumference of the first orbiting member and the second orbiting member.

9. A folder for a printing press having a drive mechanism, the drive mechanism comprising:
a first input member rotating in a first direction about a first axis;
a second input member concentric with the first input member and rotating in a second direction about the first axis, the second direction being opposite to the first direction;
a plurality of cams connected to the second input member;
an orbiting output member, the orbiting output member rotating about a second axis and orbiting about the first axis, the second axis being connected to a point on the first input member, the second axis rotating about the first axis; and
a plurality of cam followers connected to the orbiting output member and contacting the plurality of cams, the plurality of cam followers rotating about the second axis in the second direction.

11. The folder as recited in claim 9 wherein the plurality of cams are a plurality of cam surfaces.

12. The folder as recited in claim 9 wherein the first input member and second input member rotate at equal speeds.

13. The folder as recited in claim 9 wherein the orbiting output member rotates in the second direction.

14. The folder as recited in claim 9 wherein the second axis rotates about the first axis in the first rotational direction and at a same speed as the first input member.

15. The folder as recited in claim 9 wherein the plurality of cam followers rotate at the same speed as the second input member.

16. The folder as recited in claim 9 further comprising a second drive mechanism acting in unison with the first drive mechanism.

17. The folder as recited in claim 16 wherein the orbiting output member in the first drive mechanism and second drive mechanism includes a nip wheel mounted thereto so the first nip wheel and second nip wheel form a nip.

18. The folder as recited in claim 16 wherein a thickness or height of the nip wheels varies along a circumference of the orbiting output members.

19. A method for changing a pitch between consecutive signatures in a signature stream comprising the steps of:
moving a plurality of signatures at an initial velocity and an initial pitch;
rotating a nip of a first nip segment and a second nip segment at an initial velocity;
receiving a plurality of signatures at the nip;
rotating the first nip segment about a first axis and the second nip segment about a second axis;
orbiting the first nip segment about a third axis and orbiting a second nip segment about a fourth axis so as to change the initial pitch of the plurality of signatures.

20. The method as recited in claim 19 wherein the first and third axes are offset from another, and the second and fourth axes are offset from one another.
